(19) United States
(12) Patent Application Publication
(10) Pub. No.: US 2006/0173981 A1
(43) Pub. Date: Aug. 3, 2006

(54) Secure web browser based system administration for embedded platforms

(76) Inventors: Junbiao Zhang, Bridgewater, NJ (US); Saurabh Mathur, Plainsboro, NJ (US); Sachin Satish Mody, Lawrenceville, NJ (US)

Correspondence Address: THOMSON LICENSING INC., PATENT OPERATIONS, PO BOX 5312, PRINCETON, NJ, 08543-5312, US

(21) Appl. No.: 10/549,466

(22) PCT Filed: Mar. 11, 2004
(86) PCT No.: PCT/US04/07411

§ 371 Date: Sep. 14, 2005

(51) Int. Cl. G06F 15/173

(52) U.S. Cl. 709/223

(57) ABSTRACT

The invention provides a method for a web browser based remote administration system to maintain its security by utilizing an ActiveX control or a plug-in, without relying on HTTPS protection to transact management information. The invention does not burden the embedded system and thus is ideally suited for the remote administration of embedded systems. The invention provides a method to calculate a security code base upon identical algorithms in the administrative system having the browser and the embedded system. When the browser-based administrator submits the management information, an operator packages the control information as a string and invokes the security function in the plug-in with the string as a parameter. After the security function returns the result, the operator sends the form data together with a coded digest to the remote system. The digest may be embedded in the form data, for example, as a hidden field.

### RELATED APPLICATION

This application claims the benefit of U.S. Provisional Application No. 60/454,582, filed Mar. 14, 2003, and incorporated herein by reference.

### 1. FIELD OF THE INVENTION

The invention relates to a method for providing configuration changes in a network access point, and in particular, provides a method in a WLAN environment where an access point and a stationary computer or a mobile terminal maintaining a web browser utilizes an ActiveX control or a plug-in to enhance a security mechanism without relying on HTTPS protection during remote management and administration processing.

### 2. DESCRIPTION OF RELATED ART

The context of the present invention is to securely access networks, such as the World Wide Web, through another network, including wireless local area networks or (WLAN) employing the IEEE 802.1x architecture, having an access point that provides access for a stationary computer or a mobile terminal devices and to other networks, such as hard wired local area and global networks, such as the Internet. Advancements in WLAN technology have resulted in the publicly accessible wireless communication at rest stops, cafes, libraries and similar public facilities (“hot spots”). Presently, public WLANs offer mobile communication device users access to a private data network, such as a corporate intranet, or a public data network such as the Internet, peer-to-peer communication and live wireless TV broadcasting. The relatively low cost to implement and operate a public WLAN, as well as the available high bandwidth (usually in excess of 10 Megabits/second) makes the public WLAN an ideal access mechanism, through which, mobile wireless communications device users can exchange packets with an external entity. However as will be discussed below, such open deployment may compromise security unless adequate means for identification and authentication exists during regular communications and in processing remote management and administrative functions.

In a web browser based authentication method, a stationery computer or a mobile terminal communicates with an authentication server, using a web browser operating with the Hyper Text Transfer Protocol Secured Sockets (HTTPS) protocol insures that anyone on the path between the mobile terminal and the authentication server cannot trespass upon or steal confidential user information.

Remote system management/administration is a key requirement on any type of computer systems. Using web browsers (HTTP protocol) as the interface for remote management is becoming an essential management feature. In order to provide secure browser based remote management, HTTPS is the natural choice. However, for embedded systems, such as WLAN access points, the resource requirement on HTTPS may be too great consuming large amounts of storage space and requires corresponding overhead support and CPU power. In fact these limitations have historically prevented the development of a practical solution to a secure browser based administration mechanism. For example, most of today's commercially available wireless access points do not protect the remote administration exchanges between the browsers and the access points. A would be hacker might easily obtain administrator passwords and damage the access points.

HTTPS is designed for communication protocols where neither a browser nor a web server have pre-established authentication codes such as confidential passwords known only by the client terminal and the authentication server. This assumption of confidentiality is absolutely necessary in the web applications in which tens of millions of browsers may access millions of servers, but do not have a prior trust relationship. Thus a large use HTTPS requires a certificate on the server to provide a secure negotiation between the browser and the server, and the establishment of a shared secret code for subsequent HTTP communication. In the remote system administration case, the administrator and the remote device can pre-share a secret, thus removing one source of overhead associated with HTTPS communication. However, since the web browser does not offer the necessary secure communication mechanism based on such a shared secret, it would be a desirable feature for a processor to provide the security through the use of an ActiveX control or functionally equivalent plug-in.

### SUMMARY OF THE INVENTION

The invention herein provides a method for improving security during a remote administration exchange between a client device using a browser and an access point of a network. In particular, the invention provides a method for securely exchanging administration change requests between a client device and an access point of a wireless network (WLAN). The WLAN may comprise a network that complies with IEEE 802.11 standards. The administration change involves the use of parameters for ensuring that received administration information is received from an appropriate client terminal. Generally, when a request for administration management file, such as a web page, is received, the access point of the network also generates and transmits to the client terminal a first parameter, for example, a random number. The first parameter may be generated in response to a challenge following the request for the administration management file.

Using a predetermined algorithm, such as the MDS hash function, a new parameter is generated from certain parameters. The parameters may include the first parameter, which may be a random number generated by the access point. For greater security, the new parameter may be generated from several parameters, including a password associated with the client terminal, the first parameter, and a string parameter, which may, for example, be generated from the new administration information. The new parameter is transmitted from the client terminal to the access point, which then generates a corresponding new parameter using the parameters used by the client terminal. If the parameters match, the access point accepts the new administration information and implements them. In this manner, greater security is provided by using a verification parameter with the new administration information, which verification parameter is generated using parameters that are known to the client terminal and the access point.

In an embodiment of the present invention an administrator utilizes a browser to request an administrative web page form, typically designed as a Hyper Text Markup Language (HTML) form, from a remote computer, such as a local web server, which contains fields where the administrator can provide information relevant to obtaining a secure communication with the network. The web page form includes fill-in management information, which when complete is submitted to the remote computer by invoking a real time operator, such as may be provided by a Javascript code, to package the information into a string. The real time operator invokes a plug-in security function having a predetermined character string as one parameter; prompting the security function to communicate with a remote system.

Upon receiving the form information, the remote system generates a random number and stores the number for future reference. It also communicates the number to the administrator. The administrator security function concatenates the random number, an administrator password (previously stored in the plug-in) and the string parameter. Thereafter, a digest, such as a Message 5 digest (MD5), is generated for the concatenated result and is returned to the security function. The process includes utilizing the real time operator such as Javascript to then embed the result from the security function into the form containing the management information and sends the form to the remote computer, thereby completing the submission. The remote computer utilizes the stored random number, the password and the received data to generate an MD5 digest. If the digest matches the received digest then the requested administration is granted and the system is appropriately updated. In subsequent communication where management information is to be communicated from the administrator to the remote computer, the remote computer first generates a random number to be thereafter utilized by the administrator in a Message 5 digest (MD5). In each case, the remote system digest is then compared to the received digest and if the digest matches the received digest, then the requested administration request is granted and the system is updated accordingly.

### BRIEF DESCRIPTION OF THE DRAWINGS

The invention is best understood from the following detailed description when read in connection with the accompanying drawing. The various features of the drawings are not specified exhaustively. On the contrary, the various features may be arbitrarily expanded or reduced for clarity. Included in the drawing are the following figures:

FIG. 1 is a block diagram of a communications system for practicing the method of the present invention.

FIG. 2 is a flow diagram of an embodiment of the present invention for securing a communication access.

FIG. 3a is a flow diagram of an embodiment of the present invention for securing a communication access.

FIG. 3b is a flow diagram of an embodiment of the present invention for securing a communication access.

### DETAILED DESCRIPTION OF THE INVENTION

In the figures to be discussed the circuits and associated blocks and arrows represent functions of the process according to the present invention which may be implemented as electrical circuits and associated wires or data busses, which transport electrical signals. Alternatively, one or more associated arrows may represent communication (e.g., data flow) between software routines, particularly when the present method or apparatus of the present invention is implemented as a digital process.

The invention provides a method for a web browser based remote administration system to maintain its security by utilizing an ActiveX control or a plug-in, without relying on HTTPS protection to transact management information. The invention does not burden the embedded system and thus is ideally suited for the remote administration of embedded systems. The invention provides a method to calculate a security code base upon identical algorithms in the administrative system having the browser and the embedded system. When the browser-based administrator submits the management information, an operator packages the control information as a string and invokes the security function in the plug-in with the string as a parameter. After the security function returns the result, the operator sends the form data together with a coded digest to the remote system. The digest may be embedded in the form data, for example, as a hidden field.

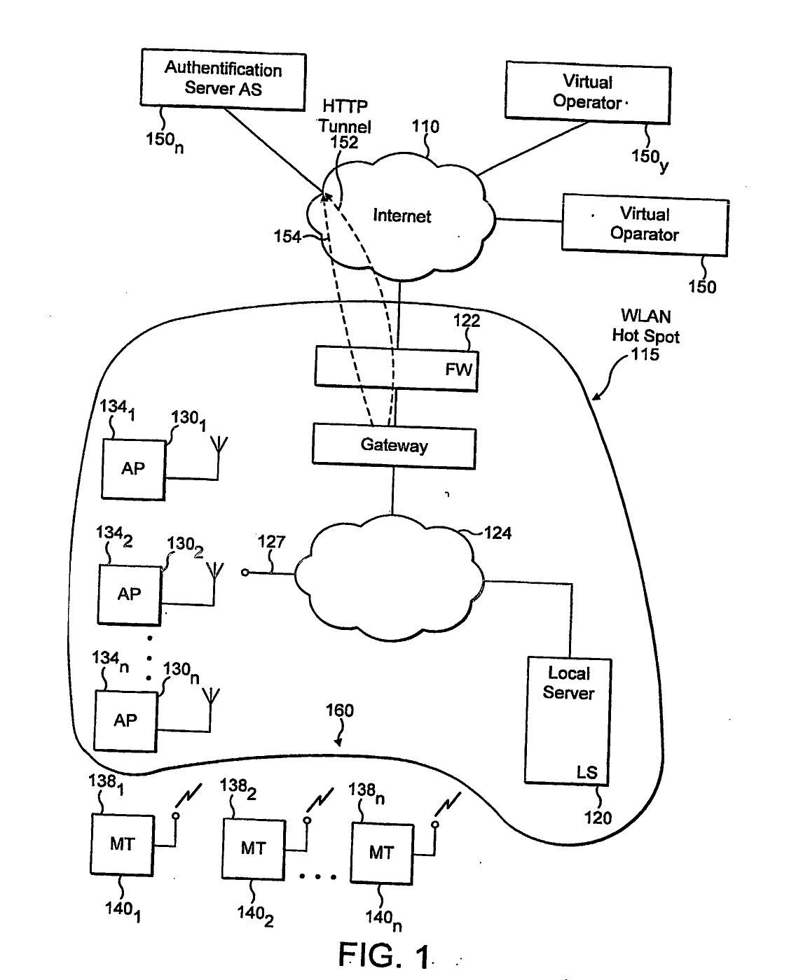

In accordance with FIG. 1, one or more mobile terminals represented by 140₁ through 140ₙ communicate via wireless medium 124 to an access point 130ₙ, local computer 120, in association with firewalls 122 and one or more virtual operators 150₁₋ₙ, such as authentication server 150n. Communication from terminals 140₁₋ₙ typically require accessing a secured data base or other resources, utilizing the Internet 110 and associated communication paths 154 and 152 that require a high degree of security from unauthorized entities, such as would be hackers.

As further illustrated in FIG. 1, the IEEE 802.1x architecture encompasses several components and services that interact to provide station mobility transparent to the higher layers of a network stack. The IEEE 802.1x network defines AP stations such as access points 130₁₋ₙ and stationary or mobile terminals 140₁₋ₙ as the components that connect to the wireless medium and contain the functionality of the IEEE 802.1x protocols, that being MAC (Medium Access Control) 138₁₋ₙ, and corresponding PHY (Physical Layer) (unshown), and a connection 127 to the wireless media. Typically, the IEEE 802.1x functions are implemented in the hardware and software of a wireless modem or a network access or interface card. This invention proposes a method for implementing in a wireless medium 124 a secure communication means between a client terminal 140ₙ, an access point 130ₙ, local server 120 and an authentication server 150.

In accordance with the present principles, the an access 160 enables each stationary or mobile terminals 140₁₋ₙ, to securely access the WLAN 115 by authenticating and thereafter providing a means to create the administrative forms that ensure a secure traffic flow between both the terminal as well as its communication system components, through such gateways 121, firewalls 122 that may exist as part of the larger network and communication paths 152 and 154 which denote HTTP and non-HTTP communication routing. The manner in which the access 160 enables such secure access can best be understood by reference to FIG. 1.

The sequence of interactions that occurs over time among a stationary or wireless communication devices, say terminal 140n, the public WLAN 115, the local web server 120, and the authentication server 150 is described under the convention of an IEEE 802.1x protocol, wherein the access point 130n of FIG. 1 maintains a controlled port and an un-controlled port, through which the access point exchanges information, with the terminals 140₁. The controlled port maintained by the access point 130, serves as the entryway for non-authentication information, such as data traffic to pass through the WLAN 115 and the terminals 140₁₋ₙ. Ordinarily, the access points 130₁₋ₙ keep the respective controlled port closed in accordance with the IEEE 802.1x protocol until the authentication of the pertinent terminal 140₁₋ₙ communicates. The access points 130₁₋ₙ always maintain the respective uncontrolled port open to permit the mobile terminals 140₁₋ₙ to exchange authentication data with an authentication server 150.

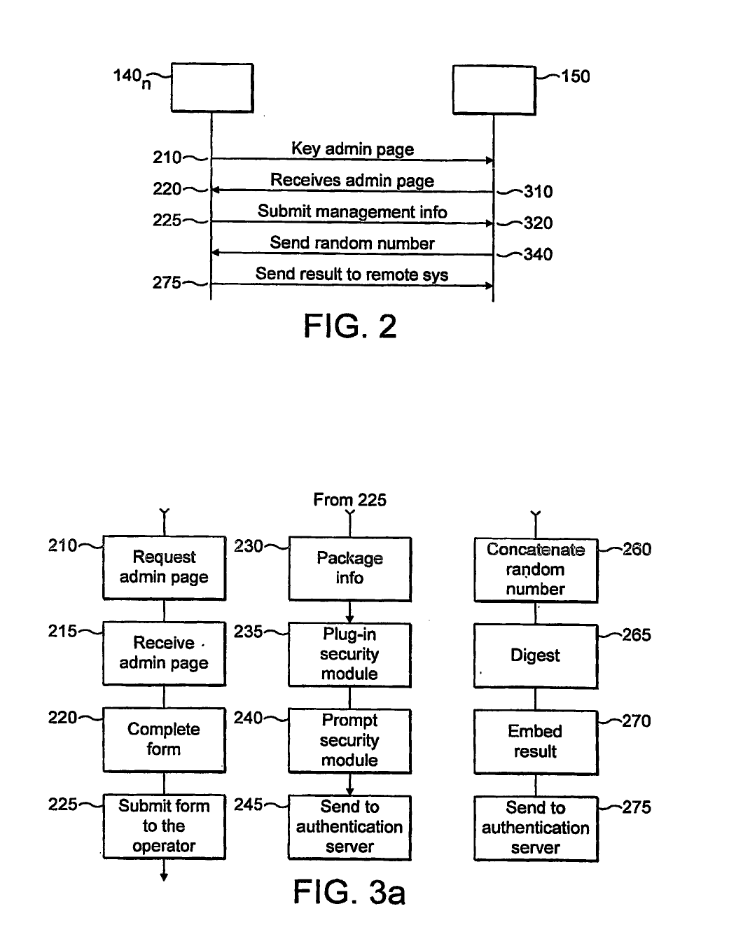

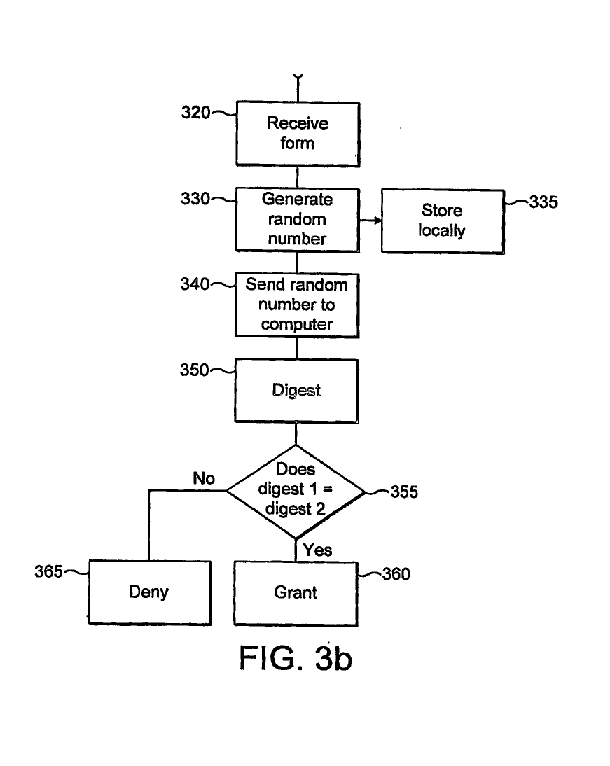

More specifically, with reference to FIG. 2 and FIG. 3a, a method in accordance with he present invention an administrator utilizes terminals 140₁₋ₙ and a browser to request 210 an administrative web page form, typically designed as an Hyper Text Markup Language (HTML) form, from a remote computer 150, which contains fields where the administrator can provide information relevant to obtaining a secure communication with the network. Upon receiving the form 215, the web page form filled-in with requested management information, which when complete 220 is submitted 225 to the remote computer 150 by invoking a real time operator, such as may be provided by a JavaScript code, to package 230 the information into a string. The real time operator invokes a plug-in security function 235 having a predetermined character string as one parameter; prompting 240 the security function to communicate 250 with a remote system 150.

Upon receiving 320 the form information, the remote system 150 generates a random number 330 and stores the number 335 for future reference. It also communicates 340 the number to the administrator 140₁₋ₙ. The administrator 140₁₋ₙ security function concatenates 260 the random number, an administrator password (previously stored in the in the plug-in) and the string parameter. Thereafter, a digest, such as a Message 5 digest (MDS), is generated 270 for the concatenated result and is returned to the security function. The process includes utilizing the real time operator such as JavaScript to then embed the result from the security function into the form containing the management information and sends 275 the form to remote computer 150, thereby completing the submission. The remote computer utilizes the stored random number, the password and the received data to generate 350 a MD5 digest. If the digest matches 355 the received digest then the requested administration is granted 360 and the system is appropriately updated. If there is no match access is denied 356. In subsequent communication where management information is to be communicated from the administrator to the remote computer 150, the remote computer 150 first generates a random number to be thereafter utilized by the administrator in a Message 5 digest (MD5). In each case, the remote system digest is then compared to the received digest and if the digest matches the received digest, then the requested administration request is granted and the system is updated accordingly.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

1. A method for exchanging administration management information with a client terminal in a wireless network, comprising the steps of:
receiving by an access point a request for an administration management file from the client terminal;
transmitting by the access point the administration management file to the client terminal;
generating by the access point and transmitting by the access point to the client terminal a first parameter;
receiving by the access point new administration information and a second parameter from the client terminal;
generating by the access point a third parameter using a predetermined algorithm and the first parameter;
comparing by the access point the third parameter to the second parameter; and
implementing the new administration information in response to the comparing step.

2. The method according to claim 1, wherein the wireless network is a wireless local area network in accordance with IEEE 802.11 standards, the client terminal is a mobile terminal within a coverage area of the wireless local area network, and the administration management file comprises an administration web page.

3. The method according to claim 2, wherein the first parameter is a random number.

4. The method according to claim 3, wherein the step of generating a third parameter comprises generating the third parameter using a hash function and the first parameter.

5. The method according to claim 3, wherein the step of generating a third parameter comprises generating a third parameter using a hash function, the first parameter, a password, and a string parameter.

6. The method according to claim 5, wherein the string parameter corresponds to the new administration information.

7. The method according to claim 2, wherein the transmitting step comprises transmitting the administration web page and Active X control to the client terminal.

8. An access point in a wireless network, comprising:
a transceiver for communicating with a client terminal;
means, coupled to the transceiver, for causing the transceiver to transmit an administration management file in response to a request from the client terminal,
means for generating a first parameter and causing the transceiver to transmit the first parameter to the client terminal, the transceiver receiving from the client terminal new administration information and a second parameter;
means for generating a third parameter in response to the first parameter, and comparing the third parameter to the second parameter; and
means for implementing the new administration information in response to the comparison.

9. The access point according to claim 8, wherein the wireless network is a wireless local area network in accordance with IEEE 802.11 standards, the client terminal is a mobile terminal within a coverage area of the wireless local area network, and the administration management file comprises an administration web page.

10. The access point according to claim 9, wherein the first parameter is a random number, and the means for generating a third parameter comprises means for generating the third parameter using a hash function, the random number, a password, and a string parameter.

11. The access point according to claim 10, wherein the string parameter corresponds to the new administration information.

12. A method for exchanging administration management information with an access point in a wireless network using a client terminal, comprising the steps of:
transmitting a request for an administration management file to the access point;
receiving the administration management file from the access point;
receiving a first parameter from the access point;
generating new administration information in response to user input;
generating a second parameter using a predetermined algorithm and the first parameter;
transmitting the second parameter and the new administration information to the access point.

13. The method according to claim 12, wherein the wireless network is a wireless local area network in accordance with IEEE 802.11 standards, the client terminal is a mobile terminal compliant with the IEEE 802.11 standards, and the administration management file is an administration web page.

14. The method according to claim 13, wherein the step of receiving the administration web page includes receiving the administration web page and an Active X control.

15. The method according to claim 13, wherein the step of generating a second parameter comprises generating the second parameter using a hash function and the first parameter.

16. The method according to claim 13, wherein the step of generating a second parameter comprises generating the second parameter using a hash function, the first parameter, a password and a string parameter.

17. The method according to claim 16, wherein the string parameter is generated from the new administration information.

18. A client terminal for communicating with an access point associated with a wireless network, comprising:
transceiver for communicating with the access point;
means coupled to the transceiver for causing the transceiver to transmit to the access point a request for an administration management file, and receiving the administration management file from the access point, and for receiving a first parameter from the access point;
means for generating new administration information in response to user input;
means for generating a second parameter using a predetermined algorithm and the first parameter;
means for causing the transceiver to transmit to the access point the second parameter and the new administration information.

19. The client terminal according to claim 18, wherein the wireless network is a wireless local area network in accordance with IEEE 802.11 standards, the client terminal is a mobile terminal compliant with the IEEE 802.11 standards, and the administration management file is an administration web page.

20. The client terminal according to claim 19, wherein the second parameter is generated using a hash function and the first parameter.

21. The client terminal according to claim 19, wherein the second parameter is generated using a hash function, the first parameter, a password and a string parameter.

22. The client terminal according to claim 21, wherein the string parameter is generated from the new administration information.
